(19) United States
(12) Patent Application Publication
(10) Pub. No.: US 2026/0143225 A1
(43) Pub. Date: May 21, 2026

(54) NETWORK DEVICE AND NETWORK CONTROL SYSTEM

(71) Applicant: ASUSTEK COMPUTER INC., TAIPEI (TW)

(72) Inventor: Ching-Chuan CHIU, TAIPEI (TW)

(21) Appl. No.: 19/052,602

(22) Filed: Feb. 13, 2025

(30) Foreign Application Priority Data
Nov. 21, 2024 (TW) 113144913

(51) Int. Cl. H04N 23/661; G06V 40/16

(52) U.S. Cl. CPC H04N 23/661; G06V 40/172

(57) ABSTRACT

A network device is provided. The network device is adapted to a local area network with a network camera. The network device comprises a network interface module, an image recognition module, and a control unit. The network interface module is used for communicating with the network camera to receive image data from the network camera. The image recognition module is used for recognizing image data to generate a result. The control unit is used for control at least one Internet of things (IoT) device in the local area network according to the result. A network control system with the network device is also provided.

### CROSS-REFERENCE TO RELATED APPLICATION

This application claims the priority benefit of Taiwan Application Serial No. 113144913, filed on Nov. 21, 2024. The entirety of the above-mentioned patent application is hereby incorporated by reference herein and made a part of specification.

### BACKGROUND OF THE INVENTION

### Field of the Invention

The disclosure relates to the technical field of network communication, and in particular, to a network device communicatively connected to a network camera for use.

### Description of the Related Art

With the development of technologies, network cameras are widely applied to home environments to ensure home security.

However, a conventional network camera has only an image capturing function, does not perform object recognition, and does not trigger other devices to operate, and is limited in use. If a network camera having an object recognition function needs to be used, relatively high setup costs are further required.

### BRIEF SUMMARY OF THE INVENTION

The disclosure provides a network device, applicable to a local area network having a network camera. The network device includes a network interface module, an image recognition module, and a control center. The network interface module is suitable for being communicatively connected to the network camera, and receiving image data from the network camera. The image recognition module is suitable for recognizing image data to generate a recognition result. The control center is suitable for controlling at least one Internet of things (IoT) device in the local area network based on the recognition result.

The disclosure further provides a network control system, applicable to a local area network. The network control system includes a network camera, an Internet of Things device, and a network device. The network device includes a network interface module, an image recognition module, and a control center. The network interface module is suitable for being communicatively connected to the network camera and the Internet of Things device, and receiving image data from the network camera. The image recognition module is suitable for recognizing image data to generate a recognition result. The control center is suitable for controlling the Internet of Things device based on the recognition result.

The network device provided in the disclosure receives the image data captured by the network camera for object recognition, and triggers a corresponding action based on a preset condition. In this case, an operation that is not performed by an original network camera is achieved, thereby helping to expand a use range of the network camera. The disclosure is applied to fields such as home security, smart home, and office monitoring.

### BRIEF DESCRIPTION OF THE DRAWINGS

FIG. 1 is a schematic diagram showing a network device according to an embodiment of the disclosure;

FIG. 2 shows an embodiment of a network control system according to the disclosure;

FIG. 3 shows another embodiment of a network control system according to the disclosure; and

FIG. 4 shows still another embodiment of a network control system according to the disclosure.

### DETAILED DESCRIPTION OF THE EMBODIMENTS

The following describes specific embodiments of the disclosure in more detail with reference to the schematic diagrams. The advantages and features of the disclosure become more apparent based on the following descriptions and the scope of the claims. It should be noted that all the drawings are in very simplified form, in inexact proportions, and only used to conveniently and clearly assist in describing the embodiments of the disclosure.

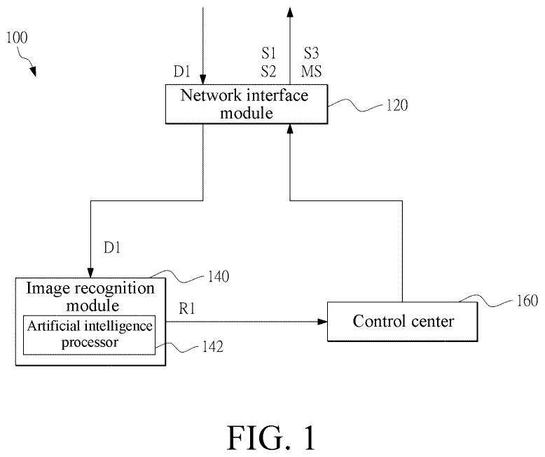

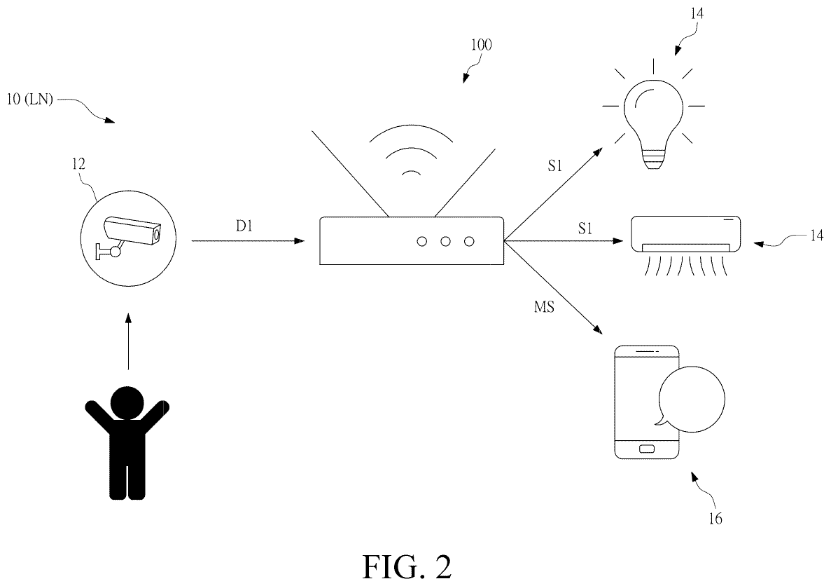

FIG. 1 is a schematic diagram showing a network device 100 according to an embodiment of the disclosure. FIG. 2 shows an embodiment of a network control system 10 according to the disclosure. A use scenario of the network device 100 in FIG. 1 is presented.

As shown in the figure, the network control system 10 includes the network device 100 in FIG. 1, a network camera 12, and at least one Internet of Things device 14 (in the figure, a single Internet of Things device 14 is shown as an example).

The network control system 10 is applicable to a local area network LN, and the network device 100, the network camera 12, and the Internet of Things device 14 are all located in the local area network LN. In an embodiment, the network device 100 may be a router.

As shown in FIG. 1, the network device 100 includes a network interface module 120, an image recognition module 140, and a control center 160.

The network interface module 120 is suitable for being communicatively connected to the network camera 12, and receiving image data D1 from the network camera 12. In an embodiment, the network interface module 120 is a wirelessly connected interface module. However, the disclosure is not limited thereto. In another embodiment, the network interface module 120 may alternatively be a wiredly connected interface module.

The image recognition module 140 is suitable for recognizing the image data D1, to generate a recognition result R1. In an embodiment, the image recognition module 140 is a facial recognition module. In an embodiment, the image recognition module 140 includes an artificial intelligence (AI) processor 142.

The control center 160 is suitable for controlling at least one Internet of things (IoT) device 14 in the local area network LN based on the recognition result R1. In an embodiment, the Internet of Things device 14 may be a lamp, an appliance, or the like, or may be the network camera 12.

In an embodiment, the control center 160 may alternatively send a prompt message MS to a mobile device 16 based on the recognition result R1. However, the disclosure is not limited thereto.

For example, if the image recognition module 140 finds, by analyzing the image data D1, that a child returns home (that is, a recognition result R1), the control center 160 generates a control signal S1 to control a lamp to light up and turn on an air-conditioning system, and sends a prompt message MS to the mobile device 16 to notify a parent.

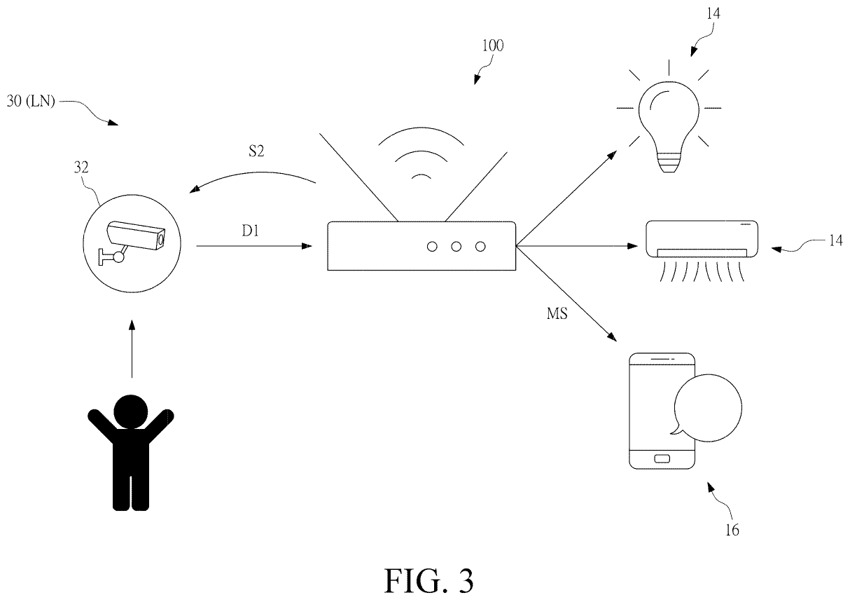

As shown in FIG. 3 together, FIG. 3 shows another embodiment of a network control system 30 according to the disclosure. The network control system 30 includes the network device 100 in FIG. 1, and another use scenario of the network device 100 in FIG. 1 is presented.

As shown in the figure, in an embodiment, the network interface module 120 receives image data D1 from the network camera 32. The image recognition module 140 recognizes the image data D1 to generate a recognition result R1.

The control center 160 is suitable for generating, based on the recognition result R1, a control signal S2 to control the network camera 32 (the network camera 32 is understood as an Internet of Things (IoT) device in the local area network LN).

For example, if the image recognition module 140 of the network device 100 finds, by analyzing the image data D1, that a home member returns home (that is, a recognition result R1), the control center 160 generates a control signal S2 to disable the network camera 32 to save electric energy.

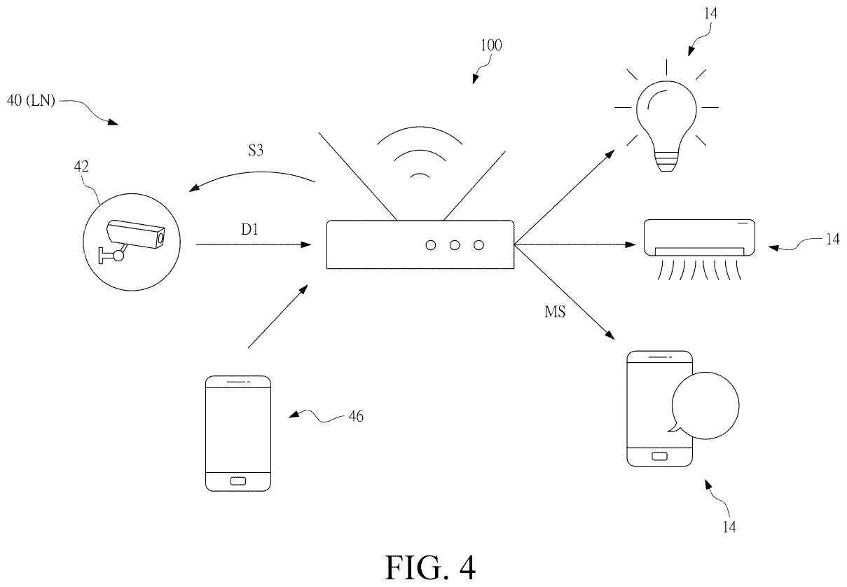

As shown in FIG. 4 together, FIG. 4 shows still another embodiment of a network control system 40 according to the disclosure. The network control system 40 includes the network device 100 in FIG. 1. Still another use scenario of the network device 100 in FIG. 1 is presented.

In an embodiment, the control center 160 is suitable for searching, by using the network interface module 120, whether a preset electronic device 46 is connected to the local area network LN, and generating, when the preset electronic device 46 is connected to the local area network LN, a control signal S3 to disable the network camera 42 (the network camera 42 is alternatively understood as an Internet of Things device). In an embodiment, the preset electronic device 46 is a mobile device.

For example, if a home member returns home, the control center 160 finds, by using the network interface module 120, that a mobile device (the preset electronic device 46) of the member is connected to the local area network LN, the control center 160 generates a control signal S2 to disable the network camera 42. Because someone is at home, the network camera does not need to be started to ensure home security, and is turned off to save electric energy.

The network device 100 provided in the disclosure receives the image data D1 captured by the network cameras 12 and 42 for object recognition, and triggers a corresponding action based on a preset condition. In the disclosure, operations that are not performed by the original network cameras 12 and 42 are achieved, thereby helping to expand use ranges of the network cameras 12 and 42. The disclosure is applied to fields such as home security, smart home, and office monitoring.

The foregoing descriptions are merely preferred embodiments of the disclosure, and are not intended to limit the disclosure. A person skilled in the art can make equivalent replacements, modifications, or other changes in any form to the technical means and technical content disclosed in the disclosure without departing from the scope of the technical means of the disclosure, which shall fall within the protection scope of the disclosure without departing from the content of the technical means of the disclosure.

What is claimed is:

1. A network device, applicable to a local area network, the local area network having a network camera, and the network device comprising:
a network interface module, suitable for being communicatively connected to the network camera and receiving image data from the network camera;
an image recognition module, suitable for recognizing the image data, to generate a recognition result; and
a control center, suitable for controlling at least one Internet of Things (IoT) device in the local area network based on the recognition result.

2. The network device according to claim 1, wherein the network interface module is a wiredly connected interface module.

3. The network device according to claim 1, wherein the network interface module is a wirelessly connected interface module.

4. The network device according to claim 1, wherein the image recognition module is a facial recognition module.

5. The network device according to claim 1, wherein the image recognition module comprises an artificial intelligence (AI) processor.

6. The network device according to claim 1, wherein the at least one Internet of Things device comprises the network camera.

7. The network device according to claim 1, wherein the control center is suitable for searching, by using the network interface module, whether a preset electronic device is connected to the local area network, and generating, when the preset electronic device is connected to the local area network, a control signal to disable the network camera.

8. The network device according to claim 7, wherein the preset electronic device is a mobile device.

9. The network device according to claim 1, wherein the network device is a router.

10. A network control system, applicable to a local area network, the network control system comprising:
a network camera;
an Internet of Things (IoT) device; and
a network device, comprising:
a network interface module, suitable for being communicatively connected to the network camera and the Internet of Things device, and receiving image data from the network camera;
an image recognition module, suitable for recognizing the image data, to generate a recognition result; and
a control center, suitable for controlling the Internet of Things (IoT) device based on the recognition result.

11. The network control system according to claim 10, wherein the network device is a router.
